(19) United States
(12) Patent Application Publication
(10) Pub. No.: US 2014/0266687 A1
(43) Pub. Date: Sep. 18, 2014

(54) WIRELESS SECURITY SENSOR REGISTRATION

(71) Applicant: DIGITAL MONITORING PRODUCTS, INC., Springfield, MO (US)

(72) Inventor: Rick A. Britton, Leawood, KS (US)

(21) Appl. No.: 13/796,973

(22) Filed: Mar. 12, 2013

(51) Int. Cl. G08C 17/02; G08B 7/06

(52) U.S. Cl. CPC G08C 17/02; G08B 7/06
USPC 340/539.1; 340/12.23; 29/825

(57) ABSTRACT

Embodiments of the present invention provide an automated method of associating a new security sensor with a control panel. In contrast to the former manual method, identification information for a new sensor is encoded within a radio frequency identification “RFID” component. The control panel includes a radio frequency identification interrogator that is able to receive the RFID code from the sensor. During installation, a technician may simply hold the sensor within the control panel's RFID component's reading range. The technician does not need to manually enter the identification number for each sensor.

### BACKGROUND

The security systems that protect homes and business from burglary, fire, and other hazards may comprise a network of wireless security sensors that communicate with a control panel. Each message broadcast by a security sensor includes a unique identification code that allows the control panel to associate the message with the sensor. Currently, a technician manually inputs each sensor's identification code into the control panel via a keypad during installation. As illustrated by FIGS. 1-3, the manual entry process is time consuming and prone to error.

Turning now to FIG. 1, a technician 104 is shown in the midst of manually registering a security sensor 110 with the control panel 106. This is done prior to installing or mounting the security sensor 110 at its ultimate location (e.g., near a window or door) to associate in the control panel 106 that specific security sensor 110 with its specific ultimate location in a home (or business) 100. The control panel is networked with other sensors within the home 100. As used herein, the term “control panel” can specifically refer to the circuit board and electrical components that run or “control” the wireless alarm system, but can also refer generically to a housing that includes any of the combination of the control panel, a keypad 108, and a wireless receiver or transceiver. It should also be understood that these three modules can be connected together and housed all within one housing (as illustrated herein), but can also be separated into different housings or any combination thereof and still be within the scope of the present invention.

The control panel 106 is located near a door 102 to allow the system to be activated and deactivated as people come and go. To associate a specific security sensor 110 with its ultimate location, the security technician 104 must manually input identification information 116 unique to that security sensor 110 into the control panel 106 using the control panel's keypad 108. The technician 104 first reads the identification information 116 printed on the security sensor 110, which can be difficult due the small text used to fit the identification information or code 116 within the small sensor 110, as shown in FIG. 2.

Turning now to FIG. 2, a detailed view of an exemplary prior art security sensor 110 and control panel 106 is shown. The security sensor 110 includes identification information 116 printed on a label within the sensor 110. To read the unique identification information, the technician 104 opens the security sensor 110. The control panel's display 112 shows the identification number 114 as it is typed on the keypad 108. This identification number 114 is then associated with a location in the home 100 (e.g., “front door”).

Additional features of the security sensor 110 are shown, including a battery 118, sensor circuitry 120, and a wireless antenna 122. The battery 118 powers the wireless sensor 110 and is replaceable. The circuitry 120 generates state information by monitoring a switch or multiple switches that open and close when a monitored feature, such as a door or window, open and close. The security circuitry 120 also includes a wireless messaging function that generates a state message that is communicated over the wireless antenna 122.

Turning now to FIG. 3, the security sensor 110 is shown in an installed location. Once the security sensor 110 is registered with the control panel 106, as described previously, the security sensor 110 is installed within the house 100. In the illustrated embodiment, the security sensor 110 happens to be mounted on the front door 102 near the top and adjacent a corresponding contact 124, in accordance with an embodiment of the present invention. The security sensor 110 pairs with the contact 124 which enables the security sensor 110 to determine when the door is opened and closed. The contact 124 may include a magnet or other material that allows a circuit to be completed via a switch within the security sensor 110.

The security sensor 110 monitors the open/closed status of door 102. When the door opens and closes, the wireless security sensor 110 sends a state message to the control panel 106. The state message includes an indication whether the door is open or closed. The state message also includes identification information unique to that security sensor 110 that allows the control panel to associate the message with that specific sensor 110 and display on the control panel's display 112 the location and status of the sensor 110 (e.g., “front door open”).

The manual registration process described in FIGS. 1-3 is time consuming and has potential for error. When the identification number is entered incorrectly the control panel 106 may not recognize the wireless state message sent by the sensor 110. If recognized, then the control panel may not correctly identify the location of the sensor 110 and incorrectly identify a source of a security breach as a result.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention provide an automated method of associating a new security sensor with a control panel. In contrast to the former manual method of FIGS. 1-3, identification information for a new sensor is encoded within a radio frequency identification “RFID” component. The control panel includes a radio frequency identification interrogator that is able to receive the RFID code from the sensor. During installation, a technician may simply hold the sensor within range of the control panel's RFID component. The technician does not need to enter the identification number manually or open the sensor.

Both the control panel and the sensor include RFID technology that allows for the exchange of identification information during set up. The sensor also includes additional wireless communication components that are separate from the RFID technology. The wireless communication components are used to communicate state updates to the control panel and receive requests from the control panel. The state updates may include security alerts and status updates. The sensor sends a security alert when a security switch opens or closes or the sensor detects other changes within a monitored environment. The status message could include a “working message” that is sent on a regular interval to let the security panel know that the battery within the sensor has energy remaining or the sensor has not otherwise malfunctioned. Other state messages may be generated by the sensor in response to an inquiry received from the control panel.

### BRIEF DESCRIPTION OF THE DRAWINGS

Embodiments of the invention are described in detail below with reference to the attached drawing figures, wherein:

FIG. 1 shows a prior art manual sensor registration process;

FIG. 2 shows a prior art control panel and the prior art security sensor from which an identification number is manually retrieved;

FIG. 3 is a diagram of an installed prior art sensor;

FIG. 4 is a diagram showing an automated sensor registration, in accordance with an embodiment of the present invention;

FIG. 5 is diagram illustrating an RFID read range, in accordance with an embodiment of the present invention;

FIG. 6 is a diagram illustrating an installed security sensor, in accordance with an embodiment of the present invention;

FIG. 7 is a flow chart showing a method of installing a security system comprising a control panel communicating wirelessly with a remote security sensor, in accordance with an embodiment of the present invention; and

FIG. 8 is a flow chart showing a method of registering an unaffiliated security sensor to a security control panel, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide an automated method of associating a new security sensor with a control panel. In contrast to the former manual method of FIGS. 1-3, identification information for a new sensor is encoded within a radio frequency identification “RFID” component. The control panel includes a radio frequency identification interrogator that is able to receive the RFID code from the sensor. The radio frequency identification interrogator includes a wireless antennae for receiving the RFID code from the sensor. It should again be noted that “control panel” as used herein can broadly refer to the housing that houses the wireless alarm system's keypad, control panel, and/or wireless receiver/transceiver modules, as illustrated herein, or may refer specifically to the circuit board and electrical components that run or “control” the wireless alarm system. Similarly, while it is stated herein that the “control panel includes a radio frequency identification interrogator”, this does not limit placement of the radio frequency identification interrogator and its wireless antennae to the circuit board and electrical components that run or “control” the wireless alarm system. In fact, the radio frequency identification interrogator and its wireless antennae may be in any of the wireless alarm system's modules, including in the wireless receiver/transceiver or the keypad. During installation, a technician may simply hold the sensor within range of the control panel's RFID component. The technician does not need to enter the identification number manually or open the sensor.

Both the control panel and the sensor include RFID technology that allows for the exchange of identification information during set up. The sensor also includes additional wireless communication components that are separate from the RFID technology. The wireless communication components are used to communicate state updates to the control panel and receive requests from the control panel. The state updates may include security alerts and status updates. The sensor sends a security alert when a security switch opens or closes or the sensor detects other changes within a monitored environment. The status message could include a “working message” that is sent on a regular interval to let the security panel know that the battery within the sensor has energy remaining or the sensor has not otherwise malfunctioned. Other state messages may be generated by the sensor in response to an inquiry received from the control panel.

As used in the present application, Radio Frequency Identification (“RFID”) technology is a broad term that covers several different forms of RFID, including Near Field Communication (“NFC”). RFID technology uses a tag associated with the sensor to communicate data to a tag reader in the control panel. The tag may be powered or passive. Possible RFID technologies may include a Passive Reader Active Tag (“PRAT”), Active Reader Passive Tag (“ARPT”), or Active Reader Active Tag (“ARAT”). In one embodiment, the RFID technology used is NFC and conforms with ISO/IEC 18092, which is hereby incorporated by reference in its entirety. NFC technology is also guided by ISO/IEC 21481, which is hereby incorporated by reference in its entirety.

The different RFID technology may use different frequency bands. In one embodiment, the RFID technology communicates within the 120-150 kHz band. In another embodiment, 13.56 MHz is used by the RFID technology in accordance with ISO/IEC 14443, which standard is hereby incorporated by reference in its entirety. In another embodiment, the RFID technology uses 902-928 MHz. Other frequencies ranges are possible, including 3.1-10 GHz, for example.

Turning now to FIG. 4, installation of a security sensor with RFID technology is shown in accordance with an embodiment of the present invention. To register the security sensor 210 with the control panel 206 the technician 104 holds the security sensor 210 within the control panel's 206 RFID range 214 (see FIG. 5). Although described in some embodiments as incorporated into the control panel 206, the RFID technology, or interrogator, could be a separate component that is plugged in to the control panel 206 during installation and removed once the installation process is complete. In this case, the control panel 206 would have an appropriate communication port. FIG. 4 shows a security system located near a door 202 inside a secured premises 200. The RFID range may vary from a few inches to several feet.

Turning now to FIG. 5, a control panel 206 and control sensor 210 with RFID technology are illustrated, in accordance with an embodiment of the present invention. FIG. 5 shows that the control panel 206 includes a keypad 208 and an RFID interrogator 212. The RFID interrogator 212 may be an internal component that is not visible on the exterior of the control panel 206. In other embodiments, including the one shown in FIG. 5, the RFID interrogator 212 includes a visible component.

In order to read the identification information on the security sensor's 210 RFID chip, the security sensor 210 is placed within the RFID read range 214. The read range 214 may vary from a few inches to several feet depending on the RFID technology used in the control panel 206 and the sensor 210.

A technician 204 may place the control panel 206 in an installation mode using the keypad 208 prior to placing the control sensor 210 within the read range 214. In addition, the keypad 208 may be used to provide or select an installation location for the sensor 210. For example, the installation location of sensor 210 may be designated a door 202. Within the control panel 206, various locations may be pre-provided. For example, a main door, a back door, a side door, or a garage door are installation locations that may be pre-provided by the control panel 206 and selected by the technician 204 for association with the security sensor 210.

As part of the sensor registration process, the control panel 206 may add the sensor to a record of sensors within the security network. For each sensor in the network, the record may include the identification information, an installation location, model information for the sensor, sensor function, and other information. During operation, the control panel 206 uses the record to match a state message with the sensor that transmitted the state message.

The identification information received via RFID technology is used to associate the sensor 210 with a wireless identification the sensor 210 includes within state messages. In one embodiment, the state messages are not transmitted using RFID technology. In one embodiment, the identification information received from the sensor 210 during installation is the exact same data used to identify the wireless state messages transmitted by the sensor 210. In other words, the identification information received during setup is included within a state message transmitted by the sensor 210 during operation. Identification information may be included within a header of a state message.

In another embodiment, only a portion of the identification information, such as the last four digits, are used to uniquely identify the state message during operation. In another embodiment, a correlation table in the control panel 206 is used to associate the identification information with a completely separate wireless identification used to identify the wireless state message transmitted by the sensor 210 during operation. The correlation table could be prepared in advance by the sensor manufacture. For example, the RFID component could come with a pre-programmed tag that stores the identification information. This tag number is associated in the correlation table with the wireless identification included within state messages by the sensor 210.

Turning now to FIG. 6, after registering the sensor 210 with the control panel 206, the sensor 210 is installed on or near the door 202. The sensor 210 is associated with a contact 224. In combination, the sensor 210 and the contact 224 allow the sensor 210 to determine whether the door is open or closed. The open/closed status of the door is communicated to the control panel 206 in a state message transmitted wirelessly.

The control panel 206 and the sensor 210 are special purpose computing devices with various computing components that enable performance of security monitoring, alarming, and related functions. The various computing components may include a bus that directly or indirectly couples the following devices: memory, one or more processors, one or more presentation components, input/output (I/O) ports, I/O components, and a power supply. Memory includes computer-storage media in the form of volatile and/or nonvolatile memory. The memory may be removable, nonremovable, or a combination thereof. Exemplary memory includes solid-state memory, hard drives, optical-disc drives, etc.

The control panel 206 includes one or more processors that read data from various entities such as a bus, memory or an I/O components. Presentation component(s) present data indications to a user or other device. Exemplary presentation components include a display device, speaker, printing component, vibrating component, etc. I/O ports allow the device to be logically coupled to other devices including I/O components, some of which may be built in. Illustrative I/O components include a microphone, scanner, printer, wireless device, etc.

In addition, the control panel 206 and sensor 210 include components that enable wireless communications. The wireless components include an antenna, a receiver, and a transmitter. In one embodiment, the wireless components are adapted for broadcast at 900 mHz. Each wireless technology used by the sensor 210 and/or control panel 206 may use a separate set of related components to broadcast or receive messages.

The invention may be described in the general context of computer code or machine-useable instructions, including computer-executable instructions, such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

The control panel 206 and sensor 210 typically include a variety of computer-readable media. Computer-readable media can be any available media that can be accessed by a computing device and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Turning now to FIG. 7, a method 700 of installing a security system comprising a control panel communicating wirelessly with a remote security sensor is shown, in accordance with an embodiment of the present invention. The control panel may be similar to control panel 206 described previously. As an initial step, the control panel may be installed within a secured premises. At step 710, the control panel is placed in an installation mode. This may be done, for example, by the technician pressing buttons on the keypad of the control panel. In an embodiment, this activates the radio frequency identification interrogator or tag reader of the control panel's RFID component. At step 720, an unaffiliated security sensor is placed within the control panel's RFID communication range. In one embodiment, the range is less than six inches. A range of less than six inches allows the sensor to be read without creating interference or accidentally reading RFID information on other nearby sensors that are yet to be installed.

At step 730, an indication is received that the control panel successfully read an RFID tag on the security sensor. The indication may be an audible or visual signal perceptible by the technician (e.g., a beep, a buzz, a vibration, a message on the display of the control panel, etc.) that indicates the control panel has received the security sensor's wireless identification information.

At step 740, the security sensor is associated with a location where the security sensor is to be installed. The association is done via the control panel. The technician may manually enter the location via buttons on the control panel or may use the buttons to scroll through and then select from a predefined or pre-populated list of locations. Other methods of associating the location with the security sensor and/or entering the location of the security sensor via the control panel are contemplated and within the scope of the present invention. For example, the control panel may have voice recognition capabilities and the technician may simply speak the location the sensor will be placed after hearing the acknowledgement beep from step 730. The voice recognition component would then convert the speech to text and display the text on the control panel for confirmation by the technician. In another embodiment the technician may have a set of cards that each include an RFID tag thereon with information stored therein that is to be transmitted using RFID technology. Each card may have a different sample location printed thereon with the corresponding information encoded into the tag. The technician scans a sensor at step 720 and then, after hearing the acknowledgement beep from step 730, scans the appropriate card with the desired location to be associated with the sensor. The technician could then press a button to confirm the association. Other methods of providing the location for association are contemplated and within the scope of the present invention.

At step 750, the security sensor is installed without manually entering the security sensor's wireless identification information into the control panel. The control panel uses the wireless identification information to uniquely identify messages received from the security sensor. As mentioned previously, a wireless security network may include multiple sensors. Each sensor uses a unique identification, described in step 750 as a wireless identification, to uniquely identify the origin of each state message. The state messages received from each wireless sensor within a network are used to record the state of a feature monitored by the sensor.

Different types of sensors may monitor different features. Open and close sensors may monitor a door or window. A motion sensor, may monitor the presence of moving objects within a secured environment. A smoke sensor monitors for smoke and a fire sensor monitors for heat. Noise sensors may monitor for the sound of broken glass or other sound associated with a security event. The control panel uniquely identifies each sensor and its location within a secured premises to generate an alarm message that includes a location near the alarming sensor. The alarm message may be sent to a recipient (e.g., a monitoring company) and/or be displayed by the control panel. This allows users and/or security personnel to quickly respond to the alarm. Because the identification information for the sensor was communicated using RFID technology, which is different than the wireless technology used to communicate the state information, there is no need for the technician to manually provide the identification information during installation.

Turning now to FIG. 8, a method 800 of registering an unaffiliated security sensor to a security control panel is shown, in accordance with an embodiment of the present invention. The sensor is a wireless sensor that communicates state information to the control panel using a wireless signal. At step 810, an instruction to enter installation mode is received at the control panel. The instruction may be generated by a technician pressing a button or a series of buttons on the control panel.

In response, a sensor-identification scanner 820 is activated at the control panel. An RFID interrogator is one example of a sensor-identification scanner. However, in an alternate embodiment, the sensor-identification scanner is a barcode reader. The barcode reader reads identification information encoded within a barcode on the sensor or on a sticker associated with the sensor. In another embodiment, the sensor-identification scanner is a camera. The camera may be used to read a barcode or other machine readable identification information printed on the sensor (e.g., a QR code).

At step 830, the identification information from the unaffiliated sensor is received through the sensor-identification scanner. The identification information may be provided as a number, a series of letters or numbers, or other uniquely identifiable mechanisms. At step 840, the unaffiliated sensor is added to the control panel's sensor network by using the identification information. The sensor may be added to the security network by augmenting a record kept within the control panel. The record may also include a location of the sensor and other information about the sensor including its intended function.

The identification information is also used to associate the sensor with identification information used to identify wireless state messages that are sent by the sensor. In one embodiment, the identification information received from the sensor during installation is the exact same identification used to identify the wireless state messages. In other words, the identification information is included within a state message, for example in a message header. In another embodiment, only a portion of the identification, such as the last four digits, are used to uniquely identify the state message. In this case, only the last four digits would be present in a state message. In another embodiment, a correlation table in the control panel is used to associate the identification information with a completely separate wireless identification used to identify the wireless state message. The correlation table could be prepared in advance by the sensor manufacture. For example, the RFID component could come with a pre-programmed number that is used for the identification information. This number is associated in the correlation table with the wireless identification included within state messages.

In one embodiment, a sensor layout plan is preloaded into the control panel and progressively populated with the appropriate sensors by the technician. The preloaded security plan may be set up by a security expert that reviews the premises and determines where the sensors should be installed. In this way, once in installation mode, each location is sequenced through the control panel as the technician holds sensors within the sensing range. For example, the control panel could go through a list of sensors to be installed in the living room and the technician could hold up the sensor that will be installed in each location within the living room. The control panel may provide a confirmation message each time the control panel receives identification information. The technician could mark the installation location on the sensor, the sensor could be pre-labeled prior to arrival at the secured premises, or the technician could install each sensor after its registration. Once registered with the control panel, the sensor is installed in its final location to perform its monitoring tasks.

Thus, embodiments of the present invention provide an automated method of registering a wireless sensor with a control panel. As part of the automated process, a machine reads identification information directly from the control sensor, without input from the person installing the sensor. In one embodiment, RFID technology is used to communicate the sensor identification information to the control panel. The automated process saves time and reduces the chance of error.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. A wireless security sensor comprising:
a sensor housing;
a radio-frequency identification (“RFID”) component coupled with the housing and that stores a sensor identification;
a wireless communication component coupled with the housing and including a wireless transmitter and a wireless antennae; and
a computing component coupled to the wireless communication component and having computer-executable code embodied thereon that, when executed, generates a sensor state message that is broadcast by the wireless communication component.

2. The wireless security sensor of claim 1, wherein the RFID component is passive.

3. The wireless security sensor of claim 1, wherein the sensor state message includes the sensor identification.

4. The wireless security sensor of claim 1, wherein the RFID component includes an RFID antennae and an RFID circuit that stores the sensor identification.

5. The wireless security sensor of claim 1, further comprising a security sensor that monitors a feature monitored by a security system.

6. A security system control panel comprising:
a panel housing;
a sensor identification component coupled with the housing;
a wireless communication component coupled with the housing and including a wireless transmitter and a wireless antennae; and
a computing component coupled to the wireless communication component and the sensor identification component and having computer-executable code embodied thereon that, when executed, receives state messages from one or more sensors and generates an alarm when a state message indicates a condition that matches an alarm trigger.

7. The control panel of claim 6, wherein the sensor identification component is a radio-frequency identification (“RFID”) interrogator.

8. The control panel of claim 6, wherein the sensor identification component is a camera.

9. The control panel of claim 6, wherein the computer-executable code includes instructions to associate sensor identification information received from the sensor identification component that identifies a wireless security sensor with the wireless security sensor when the wireless security sensor is added to the control panel's sensor network.

10. A method of installing a security system comprising a control panel communicating wirelessly with a remote security sensor, the method comprising:
placing an unaffiliated security sensor within the control panel's RFID communication range; and
installing the security sensor without manually entering into the control panel any information related to a wireless identification that the security sensor includes within wireless state updates.

11. The method of claim 10, further comprising associating the security sensor with a location where the security sensor is to be installed via the control panel.

12. The method of claim 10, further comprising receiving an indication that the control panel successfully read an RFID tag on the security sensor.

13. The method of claim 10, wherein the control panel uses near field communication RFID technology.

14. One or more computer-storage media having computer-executable instructions embodied thereon that when executed by a computing device perform a method of registering an unaffiliated security sensor to a control panel, the method comprising:
receiving, at the control panel, an instruction to enter installation mode;
activating, at the control panel, a sensor-identification scanner;
receiving, from the sensor-identification scanner, identification information from the unaffiliated security sensor; and
adding, at the control panel, the security sensor to the control panel's sensor network by using the identification information.

15. The media of claim 14, wherein the method further comprises:
receiving, at the control panel, a label for the security sensor that describes a location within a secured premises the security sensor monitors; and
associating, within the control panel, the label with the security sensor.

16. The media of claim 14, wherein the sensor-identification scanner is a radio-frequency identification (“RFID”) interrogator.

17. The media of claim 14, wherein the sensor-identification scanner is a camera.

18. The media of claim 14, wherein the sensor-identification scanner is a bar code scanner.

19. The media of claim 14, wherein the method further comprises receiving a wireless status update from the security sensor that includes the identification information.

20. The media of claim 14, wherein the method further comprises:
deriving an identification code from the identification information; and
receiving a wireless status update from the security sensor that includes the identification code.
